(19) United States
(12) Patent Application Publication
(10) Pub. No.: US 2022/0145152 A1
(43) Pub. Date: May 12, 2022

(54) COATING MATERIAL AND PREPARATION METHOD THEREOF, HEAT EXCHANGER AND METHOD FOR TREATING HEAT EXCHANGER

(71) Applicant: Hangzhou Sanhua Research Institute Co., Ltd., Hangzhou (CN)

(72) Inventors: Hai HUANG, Hangzhou (CN); Ming XUE, Hangzhou (CN); Jianhua TANG, Hangzhou (CN); Linjie HUANG, Hangzhou (CN)

(21) Appl. No.: 17/565,247

(22) Filed: Dec. 29, 2021

Related U.S. Application Data
(63) Continuation of application No. PCT/CN2021/124067, filed on Oct. 15, 2021.

(30) Foreign Application Priority Data
Nov. 11, 2020 (CN) 202011255581.5

(51) Int. Cl. C09K 5/02; C09D 183/04; C08K 3/36; C09D 7/20; C09D 7/61

(52) U.S. Cl. CPC C09K 5/02; C09D 183/04; C09D 7/61; C09D 7/20; C08K 3/36

(57) ABSTRACT

The present disclosure relates to the technical field of material and heat exchange and in particular, to a coating material applied to a heat exchanger, a method of preparing the coating material, a heat exchanger, and a method of treating the heat exchanger. The coating material of the present disclosure applied to a heat exchanger includes a hydrophobic material and a light-to-heat conversion material. Under irradiation of visible light, the light-to-heat conversion material can effectively increase the surface temperature of a coated object, which is beneficial to increasing the surface temperature of the coated object while exerting the hydrophobic performance of the hydrophobic material, thus further improving the effect in slowing down frosting.

### CROSS-REFERENCE TO RELATED APPLICATIONS

The present disclosure is a continuation of International Application No. PCT/CN2021/124067, filed on Oct. 15, 2021, which claims priority to Chinese Application No. 202011255581.5, filed on Nov. 11, 2020, the content of both are incorporated herein by reference in its entirety.

### TECHNICAL FIELD

The present disclosure relates to a technical field of material and heat exchange and in particular, to a coating material and preparation method thereof, a heat exchanger and a method for treating a heat exchanger.

### BACKGROUND

In some application scenarios, a micro-channel heat exchanger is prone to frost, resulting in a decrease in heat transfer coefficients of the heat exchanger and blockage of air ducts between fins, thereby reducing air volume, which directly affects heat exchange efficiency of a heat exchanger of a heat pump system and a pressure drop on an air side.

In a related art, a surface of a heat exchanger is mostly coated with a hydrophobic coating material, so as to increase a contact angle between water droplets formed at an initial stage of frosting and a wall surface and reduce the contact area by hydrophobic surface of the heat exchanger, so that the water droplets freeze slowly, which has some effects in slowing down the forming of initial frost crystals. However, it is still required to improve effects of hydrophobic coating layer in slowing down frosting in the related art, and correspondingly, there still exists serious problems of easily frosting and deterioration of heat exchange performance for heat exchangers. Therefore, it is required to improve the coating layers and the heat exchanger in the related art.

### SUMMARY

According to an aspect of the present disclosure, a coating material applied to a heat exchanger is provided, the coating material including a hydrophobic material and a light-to-heat conversion material.

According to another aspect of the present disclosure, a preparation method of a coating material applied to a heat exchanger is provided, the preparation method including:

providing a hydrophobic material and a light-to-heat conversion material; and

mixing the hydrophobic material with the light-to-heat conversion material to obtain the coating material.

The coating material of the present disclosure includes a hydrophobic material and a light-to-heat conversion material. The light-to-heat conversion material can effectively increase a surface temperature of a coated object under visible light, which is beneficial to increasing the surface temperature of the coated object on the basis of that hydrophobic performance of the hydrophobic material is effectively exerted. In this way, the surface of the coated object achieves a hydrophobic property while having increased surface temperature under visible light.

According to another aspect of the present disclosure, further provided is a heat exchanger, the heat exchanger includes at least one header, a plurality of heat exchange tubes and at least one fin, the heat exchange tube is fixed to the header, an inner cavity of the heat exchange tube is in communication with an inner cavity of the header, and the fin is located between two adjacent heat exchange tubes;

the heat exchanger further includes a coating layer, the coating layer is applied to at least part of an outer surface of at least one of the header, the heat exchange tube and the fin, and the coating layer includes a light-to-heat conversion material.

According to another aspect of the present disclosure, provided is a method for treating a heat exchanger, the method for treating the heat exchanger includes:

providing a heat exchanger and a coating material, the heat exchanger includes at least one header, a plurality of heat exchange tubes and at least one fin, the heat exchange tube is fixed to the header, an inner cavity of the heat exchange tube is in communication with an inner cavity of the header, and the fin is fixed between two adjacent heat exchange tubes, and the coating material includes a light-to-heat conversion material; and

applying the coating material to at least part of an outer surface of at least one of the header, the heat exchange tube and the fin.

For the heat exchanger of the present disclosure, by applying the coating material to at least part of the surface of at least one of the header, the heat exchange tube and the fin of the heat exchanger, the light-to-heat conversion material can effectively improve the surface temperature of the heat exchanger under visible light, thereby being beneficial to slowing down the frosting when the heat exchanger is operated as an evaporator in an air conditioning system.

The additional aspects and advantages of the present disclosure will be set forth in part in the following description and become apparent in part from the following description, or be understood through practice of the present disclosure.

### BRIEF DESCRIPTION OF DRAWINGS

FIG. 1 is a schematic structural diagram of a heat exchanger according to an embodiment of the present disclosure;

FIG. 2 is an enlarged schematic diagram of an assembly structure of part of components of the heat exchanger in FIG. 1;

FIG. 3 is a schematic diagram of a combination of a metal base material and a coating layer according to an embodiment of the present disclosure; and

FIG. 4 is a surface temperature test diagram of some embodiments of the present disclosure and Comparative Example 2.

### REFERENCE SIGNS

100—heat exchanger; 10—header; 11—coating layer; 12—heat exchange tube; 121—heat exchange channel; 13—fin; 131—fin unit; 41—metal base material; 42—rough surface.

### DESCRIPTION OF EMBODIMENTS

For clear description of the objectives, technical solutions, and advantages of embodiments of the present disclosure, the technical solution of the present disclosure will be described clearly and completely below with reference to the embodiments of the present disclosure. It is apparent that the described embodiments are some of, not all the embodiments of the present disclosure. All other embodiments obtained by a person of ordinary skill in the art based on the technical solutions and the embodiments of the present disclosure without creative efforts shall fall within the scope of the present disclosure. Those without specific conditions in the examples are generally implemented under conventional conditions or conditions recommended by the manufacturers. The reagents or instruments used without specifying the manufacturers are all conventional products that can be purchased commercially.

The endpoints and any values of the ranges disclosed herein are not limited to the precise ranges or values, and these ranges or values should be understood to include values close to these ranges or values. For numerical ranges, the endpoint values of each range, the endpoint values of each range or individual point values, and the individual point values can be combined with each other to obtain one or more new numerical ranges.

It should be noted that the term “and/or” or “/” used herein refers only to an association relationship describing associated objects and indicates that there can be three relationships, for example, A and/or B can indicate three cases: only A exists, A and B exist at the same time, and only B exists. The singular forms “a”, “said” and “the” as used in embodiments of the present disclosure and the appended claims are also intended to include plural forms unless otherwise other meanings are explicitly indicated in the context.

In an embodiment, the present disclosure will be further described in detail below through specific embodiments.

In a related art, a micro-channel heat exchanger is an efficient heat exchange device developed in the 1990s, and may be widely used in the fields of chemical, energy, environmental or the like. As the micro-channel heat exchanger has many different characteristics, such as a small size, a light weight, high efficiency, high strength and the like, comparing with devices of conventional sizes, micro-channel technology triggered technological innovations in improving efficiency and reducing emissions in the fields of thermal management systems for new energy vehicles, household air conditioners, commercial air conditioners, and refrigeration devices simultaneously.

In a related art, while application of an all-aluminum micro-channel heat exchanger is gradually expanding, its generalization progress is relatively slow. One of the main technical bottlenecks is that a special flat-tube parallel structure mostly adopted to a plurality of heat exchange tubes and a heat exchanger structure equipped with fins for enhancing heat exchange makes it difficult to remove the condensed water on the surface of the heat exchange tubes and the fins, easy to frost, but difficult to defrost, and as a result, the frosting phenomenon becomes more obvious for the all-aluminum micro-channel heat exchanger while being operated in a heat pump system. Therefore, it is an problem to be urgently solved in the industry to enable existing thermal management systems, such as low-temperature heat pump air-conditioning heat exchange systems, to have a certain function of slowing down frosting, and to develop a novel coating material for slowing down frosting to improve heat exchange efficiency.

On the basis, the technical solutions of the embodiments of the present disclosure provide a coating material that can be used to a heat exchanger to effectively slow down frosting and a preparation method thereof, a heat exchanger and a treatment method thereof, where a light-to-heat conversion material is used for further slowing down frosting of the heat exchanger, so as to improve the heat exchange efficiency. Specific technical solutions are described as follows.

The coating material of the present disclosure includes a hydrophobic material and a light-to-heat conversion material. In some implementations, a dispersant is also included.

In some implementations, the hydrophobic material is a hydrophobically modified silica sol. It should be understood that the hydrophobically modified silica sol has better hydrophobicity.

The hydrophobically modified silica sol is prepared from the following parts of raw materials by mass:

10 to 50 parts of organosilane and/or siloxane, 45 to 89 parts of a solvent, and 1 to 5 parts of hydrophilic silica by mass.

The hydrophobically modified silica sol is mainly prepared from appropriate dosages of suitable organosilane and/or siloxane, solvent, and hydrophilic silica, where the organosilane and/or siloxane are hydrophobic materials, which can not only exert their own basic properties, such as high and low-temperature resistance, oxidation stability, weather resistance, low surface tension and the like, but also modify hydrophilic silica in the presence of a suitable solvent, so that the hydrophilic silica is enabled to have a certain hydrophobicity by the excellent hydrophobicity of the organosilane and/or siloxane. Moreover, the hydrophobically modified silica sol in the embodiments of the present disclosure is determined by comprehensively considering the contribution of various raw materials to the comprehensive performance indicators, such as hydrophobicity, compatibility, and synergy of the entire system, of the hydrophobically modified silica sol. Through synergistic coordination effect of the abovementioned specific contents of the organosilane and/or siloxane, the solvent and the hydrophilic silica, various properties are balanced, so as to obtain a hydrophobic modified silica sol with excellent performance, and especially, the hydrophobic modified silica sol is enabled to have better hydrophobicity.

It should be understood that after the coating material containing the abovementioned hydrophobically modified silica sol is applied to a heat exchanger, at least part of the surface of the heat exchanger presents hydrophobicity to slow down frosting. The hydrophobic surface can increase a contact angle between water droplets formed at the initial stage of frosting and a wall surface of the heat exchanger and reduce a contact area, so that the water droplets freeze slowly, which slows down initial formation of frost crystals.

According to the embodiments of the present disclosure, raw materials for preparation of the hydrophobically modified silica sol may include the organosilane, or may include the siloxane, or may include both the organosilane and the siloxane. If both the organosilane and the siloxane are used for the hydrophobically modified silica sol, there is no restriction on a ratio of the organosilane to the siloxane, as long as a total dosage of the organosilane and the siloxane is within the dosage range defined in the present disclosure, such as 10 to 50 parts by mass. The dosage in part by mass of the organosilane and/or the siloxane is 10 to 50 parts, for typical but non-limiting example, may be 10 parts, 15 parts, 20 parts, 25 parts, 30 parts, 35 parts, 40 parts, 45 parts, 50 parts by mass, and any value in a range formed by any two of these point values.

According to the embodiments of the present disclosure, raw materials for preparation of the hydrophobic modified silica sol includes a solvent, and a dosage of the solvent is 45 to 89 parts, for typical but non-limiting example, may be 45 parts, 50 parts, 58 parts, 60 parts, 65 parts, 70 parts, 75 parts, 80 parts, 82 parts, 89 parts by mass, and any value in a range formed by any two of these point values.

According to the embodiments of the present disclosure, raw materials for preparation of the hydrophobic modified silica sol includes hydrophilic silica, and a dosage of the hydrophilic silica is 1 to 5 parts, for typical but non-limiting example, may be 1 part, 1.5 parts, 2 parts, 2.5 parts, 3 parts, 3.5 parts, 4 parts, 4.5 parts, 5 parts by mass, and any value in a range formed by any two of these point values.

According to the embodiments of the present disclosure, the hydrophobically modified silica sol can synergize with other raw materials by adjusting the types and proportions of the raw materials. By using the raw materials of which the dosages are provided within the above-mentioned ranges, the hydrophobically modified silica sol can achieve good hydrophobicity and stable performance.

Unless otherwise specified, the percentages, ratios or parts involved herein are based on mass. “Part by mass” used here refers to a basic measurement unit of the mass ratio relationship of multiple components, and 1 part may represent any unit mass, for example, 1 part may be represented as 1 g, 1.68 g, 5 g, or the like.

Further, in order to further optimize the dosage of each component in the hydrophobically modified silica sol and improve the synergistic coordination effect of the components, in some embodiments, the hydrophobically modified silica sol is prepared from the following raw materials: 20 to 40 parts of the organosilane and/or the siloxane, 50 to 80 parts of the solvent, and 1 to 3 parts of the hydrophilic silica by mass.

By rationally adjusting and optimizing the dosage of each component in the hydrophobically modified silica sol, the synergistic coordination of the components can be fully exerted to further improve the properties, such as hydrophobicity, of the material. At the same time, it is also beneficial to reducing the production cost of the hydrophobically modified silica sol and improving the economic benefits of the coating material.

In the case of meeting requirement for hydrophobicity property of the hydrophobically modified silica sol or meeting requirement for slowing down frosting of the coating material, specific type of the hydrophobic material organosilane may be varied. Specifically, in some embodiments, the organosilane includes at least one of hexamethyldisilazane (HMDS for short), i.e., (CH₃)₃Si—NH—Si(CH₃)₃, methyltriethoxysilane (MTES for short), dimethyl diethoxysilane (DDS for short), trimethylchlorosilane (TMCS for short), dimethyldichlorosilane, and γ-glycidoxypropyltrimethoxysilane (KH-560 for short). Exemplarily, the organosilane may be HMDS, MTES, DDS, TMCS, dimethyldichlorosilane or KH-560, or may be a mixture of any two or more of HMDS, MTES, DDS, TMCS, dimethyldichlorosilane, and KH-560 in any ratio.

In addition, in other embodiments, the organosilane is not limited to those enumerated above. In the case of meeting the requirement for the hydrophobicity property of the hydrophobically modified silica sol or meeting the requirement for slowing down frosting of the coating material, other types of organosilanes, such as monomethyltrichlorosilane and other similar chlorosilanes, may also be used, which will not be described in detail here.

The use of HMDS, MTES, DDS, TMCS and other types of organosilanes is more helpful to improve the hydrophobicity of silica to prepare hydrophobically modified silica sols with better hydrophobicity.

In the case of meeting the requirement for the hydrophobicity property of the hydrophobically modified silica sol or meeting the requirement for slowing down frosting of the coating material, the specific types of the solvent and the hydrophilic silica may be varied. In some embodiments, the solvent includes an alcohol solvent.

Further, the alcohol solvent includes an alcohol solvent having 1 to 10 carbon atoms, preferably an alcohol solvent having 1 to 8 carbon atoms, and more preferably an alcohol solvent having 1 to 4 carbon atoms.

Further, in some embodiments, the solvent is any one of methanol, ethanol, and isopropanol or a mixture of any two or more of methanol, ethanol, and isopropanol in any ratio.

The use of an alcohol solvent such as methanol, ethanol, isopropanol, and the like is helpful for modification of hydrophilic silica by the organosilane and/or the siloxane, and the alcohol solvent has a wide range of sources and is easy available and low in cost.

Specifically, in some embodiments, the hydrophilic silica includes at least one of fumed silica particles and dispersible silica sol.

The coating material of the present disclosure also includes a light-to-heat conversion material. The light-to-heat conversion material presents a nano-scale particle structure after heat treatment, which is beneficial to better coating the surface of the heat exchanger.

That is, the coating material includes the hydrophobically modified silica sol and the light-to-heat conversion material. The light-to-heat conversion material can absorb light and convert light energy into heat energy, so that the temperature of the light-to-heat conversion material can be raised. In this way, on the one hand, the coating material improves hydrophobicity by the hydrophobicity property of the hydrophobically modified silica sol, improves the drainage and defrosting performance of a surface, which can promote the discharge of condensed water in a confined space and slow down frosting. On the other hand, the coating material can effectively increase the surface temperature of the heat exchanger and slow down the surface frosting under the irradiation of visible light by the property of the light-to-heat conversion material which can convert light into heat energy.

Therefore, a low surface energy coating layer which isn't easy to have water condensed thereon or have frost formed thereon can be formed on the surface of the heat exchanger by the coating material through the synergistic coordination of the hydrophobically modified silica sol and the light-to-heat conversion material, which can increase the surface temperature of the heat exchanger effectively under the irradiation of visible light, slow down the frosting on the surface, promote the discharge of condensed water in a confined space, and effectively exert the properties of the super-hydrophobic surface in discharging the condensed water and slowing down frosting.

In the case of meeting the requirement of the coating material for slowing down frosting, the specific types of the light-to-heat conversion material may be varied. Specifically, in some embodiments, the light-to-heat conversion material includes at least one of nano copper oxide, a spinel material, a nano carbon material, a conjugated polymer, black phosphorous, and a noble metal nanomaterial. Exemplarily, the light-to-heat conversion material may be nano copper oxide, a spinel material, a nano carbon material, a conjugated polymer, black phosphorus, or a notable metal nanomaterial, or may be a mixture of any two or more of the above-mentioned light-to-heat conversion materials in any ratio.

In that case, the nano carbon material includes, but is not limited to, carbon nanomaterial, such as graphite, carbon nanotubes, graphene, reduced graphene and the like. The carbon atoms in these materials form a huge conjugated system. Therefore, these materials have strong absorption of light and show strong light-to-heat conversion ability.

In that case, the notable metal nano material includes, but is not limited to, inorganic nano materials, such as nano gold, nano palladium, and nano platinum.

In that case, the conjugated polymer includes, but is not limited to, polyaniline and indolyl conjugated polymers.

In addition, in other embodiments, the light-to-heat conversion material is not limited to the materials enumerated above. In the case of meeting the requirement of the coating material for slowing down frosting, other types of light-to-heat conversion materials may be used, such as transition metal carbides and other materials with light-to-heat conversion property, which will not be described in detail here.

In some implementations, considering that heat exchange performance of the heat exchanger will be subject to the increase in surface temperature, application of the coating material to the surface of the heat exchanger can increase the surface temperature of the heat exchanger. Therefore, the dosage of the hydrophobically modified silica sol is 92 to 98.5 parts by mass and the dosage of the light-to-heat conversion material is 0.5 to 3 parts by mass. In these ranges, the surface temperature of the heat exchanger can be increased to an ideal range, that is, nether being increased excessively nor being increased insignificantly, so as to ensure the heat exchange performance of the heat exchanger under the premise of ensuring certain property of slowing down frosting. In order to facilitate the preparation of the coating material and improve the compatibility or dispersion uniformity of the system, the coating material may further include a dispersant, specifically, the dispersant may include at least one of a polymer dispersant, an anionic wetting dispersant, a cationic wetting dispersant, a non-ionic wetting dispersant, an amphoteric wetting dispersant, and an electrically neutral wetting dispersant. Among them, the polymer dispersant is most commonly used and have the best stability. The polymer dispersants are also divided into polycaprolactone polyol-polyethyleneimine block copolymer dispersants, acrylate polymer dispersants, polyurethane or polyester polymer dispersants, and the like. Since their anchoring groups are entangled and adsorbed with resin at one end and encapsulated with pigment particles at the other end, their storage stability is relatively good.

The anionic wetting dispersant may also be selected as the dispersant. Most of the anionic wetting dispersants are composed of a non-polar lipophilic hydrocarbon chain part with negative charges and a polar hydrophilic group. The two groups are located at two ends of a molecule, respectively, so as to form an asymmetric hydrophilic and lipophilic molecular structure. The anionic wetting dispersant may be, for example, sodium oleate (C₁₇H₃₃COONa), carboxylate, sulfate (R—O—SO₃Na), sulfonate (R—SO₃Na), and the like. The anionic dispersants have good compatibility and are widely used in water-based coating materials and inks. In addition, polycarboxylic acid polymers may also be used as controlled flocculation dispersants.

The cationic wetting dispersant may also be selected as the dispersant. The cationic wetting dispersant is a compound having non-polar groups with positive charges, which mainly includes amine salts, quaternary ammonium salts, pyridinium salts, and the like. The cationic surfactant has strong adsorption power and has a good dispersing effect on carbon black, various iron oxides, and organic pigments. However, it should be noted that the cationic surfactant chemically reacts with the carboxyl group in a base material, and it should also be noted that the cationic surfactant cannot be used together with an anionic dispersant.

The non-ionic wetting dispersant may also selected as the dispersant. The non-ionic wetting dispersant is neither ionized nor charged in water, and has relatively weak adsorption on the surface of the pigment. The non-ionic wetting dispersant is mainly used in water-based coating materials. The non-ionic wetting dispersants are mainly divided into a glycol type and a polyol type, which can reduce surface tension and improve wettability. The non-ionic wetting dispersant may be used together with an anionic dispersant.

The amphoteric wetting dispersant which is a compound composed of anions and cations may also be selected as the dispersant. For example, a phosphate salt type high molecular polymer may be used. The electrically neutral wetting dispersant may also be selected as the dispersant, where anionic and cationic organic groups in its molecule are basically the same in size, and the entire molecule is neutral but has polarity. For example, oleyl amino oleate (C₁₈H₃₅NH₃OOCC₁₇H₃₃) may be used.

Further, the dosage of each component in the coating material of the implementations of the present disclosure is defined as follows: a dosage of the hydrophobically modified silica sol is 92 to 98.5 parts by mass, a dosage of the light-to-heat conversion material is 0.5 to 3 parts by mass, and a dosage of the dispersant is 1 to 5 parts by mass. Within these limited ranges in parts by mass, the synergistic coordination of the components is good, which can prevent the surface temperature of the heat exchanger from rising too high, so as to ensure the heat exchange performance of the heat exchanger under the premise of ensuring certain property of slowing down frosting. Certainly, in other implementations, the dosages of the hydrophobically modified silica sol, the light-to-heat conversion material, and the dispersant in the coating material may also be in other ranges. In practice, the proportion of the above-mentioned different components in parts by mass may be determined according to the performance requirements of coated products, and this will not be defined in detail in the present disclosure.

Some embodiments of the present disclosure provide a preparation method of a coating material, where the coating material may be the coating material described in the abovementioned implementations, and the preparation method includes:

(a) providing a hydrophobic material and a light-to-heat conversion material; and

(b) mixing the hydrophobic material with the light-to-heat conversion material to obtain the coating material.

In some implementations, the hydrophobic material is prepared by the following steps: mixing 10 to 50 parts by mass of organosilane and/or siloxane, 45 to 89 parts by mass of a solvent and 1 to 5 parts by mass of hydrophilic silica, and stirring for 15 to 45 min at a temperature of 30° C. to 45° C. with a speed of 200 to 500 rpm to obtain the hydrophobic material.

In some implementations, prior to mixing to obtain the coating material in step (b), the preparation method further includes: adding 1 to 5 parts by mass of a dispersant to the hydrophobic material obtained in step (a). That is, in this case, step (b) specifically includes: adding a dispersant to the hydrophobic material and the light-to-heat conversion material obtained in step (a) by mass, and mixing the resulting solution thoroughly to obtain the coating material.

In some implementations, firstly, the hydrophobic material and the light-to-heat conversion material may be mixed, and then the dispersant may be added. Or the dispersant, the hydrophobic material and the light-to-heat conversion material may be mixed together to obtain the coating material. It should be understood that the present disclosure does not limit the order of adding the above-mentioned raw materials.

The preparation process of the coating material is simple, easy to control, high in feasibility, and less polluted to the environment, which is suitable for industrial mass production.

The coating material obtained by this preparation method has the characteristic of slowing down frosting of a hydrophobic surface, has better hydrophobic performance, and can facilitate and improve the discharge of the condensed water of the coating layer in a confined space, which can make the surface temperature of the heat exchanger increase effectively under the irradiation of visible light, slow down frosting, and effectively exert the properties of the super-hydrophobic surface in discharging condensed water and slowing down frosting.

It should be understood that the preparation method of the coating material and the aforementioned coating material are based on the same application concept. For the raw material composition and proportion of the coating material and other related features, reference is made to the description of the aforementioned coating material section, and it will not be repeated here.

Further, in some embodiments, in the preparation step of the hydrophobic material, the reaction occurs under mechanical stirring for 15 to 45 min in a water bath at a temperature of 30° C. to 45° C., and the stirring speed is within a range of 200 to 500 rpm. Exemplarily, the temperature of the stirring is, for example, 30° C., 32° C., 35° C., 36° C., 38° C., 40° C., 45° C., or the like, and the time of the stirring is, for example, 15 min, 20 min, 25 min, 30 min, 35 min, 40 min, 45 min, or the like, and the stirring speed is, for example, 200 rpm, 250 rpm, 300 rpm, 400 rpm, 500 rpm, or the like.

In order to prevent the temperature of the coating layer formed by the coating material applied to the heat exchanger from rising too high, the dosage of the light-to-heat conversion material needs to be controlled. Generally, the temperature rise of the coating layer should not exceed 2° C. If the temperature rise of the coating layer exceeds 2° C., the heat exchange efficiency of the heat exchanger will decrease. In some embodiments, in step (b), the dosage of the hydrophobic material added is 92 to 98.5 parts by mass, for typical but non-limiting example, may be 92 parts, 93 parts, 93.5 parts, 94 parts, 94.5 parts, 95 parts, 95.5 parts, 96 parts, 96.5 parts, 97 parts, 97.5 parts, 98 parts, 98.5 parts by mass, and any value in a range formed by any two of these point values. The dosage of the light-to-heat conversion material is 0.5 to 3 parts by mass, or may be 0.5 to 2.5 parts by mass in some embodiments, or further may be 1 to 2 parts by mass in other embodiments; for typical but non-limiting example, it may be 0.5 part, 1 part, 1.5 parts, 2 parts, 2.5 parts, 3 parts by mass and any value in a range formed by any two of these point values. The dosage of the dispersant is 1 to 5 parts by mass, or may be 2 to 4 parts by mass in some embodiments, or further may be 3 parts by mass, for typical but non-limiting example, may be 1 part, 1 part, 2 parts, 3 parts, 4 parts, 5 parts by mass and any value in a range formed by any two of these point values.

Test verification indicates that the coating material prepared under the above conditions can effectively control the temperature rise of the prepared coating film not to exceed 2° C., which ensures the heat exchange performance.

According to practical conditions, in practical applications, the coating material obtained through step (b) may be further diluted to meet different usage requirements. In some embodiments, the preparation method further includes:

(c) diluting the coating material obtained in step (b) with a solvent.

The coating material obtained in step (b) may be called stock solution of the coating material. In view of economic performance, the stock solution of the coating material may be diluted to a certain extent. When coating the heat exchanger, the diluted stock solution is applied to at least part of the surface of the heat exchanger. Certainly, step (c) may also be considered as a pretreatment step for preparing the heat exchanger; that is, the method for preparing the coating material in the embodiment of the present disclosure includes steps (a) and (b), but does not include step (c). Subsequent implementations related to the preparation of the heat exchanger according to the present disclosure will be described in detail.

An embodiment of the present disclosure provides a heat exchanger. Specifically, at least part of a surface of the heat exchanger is provided with a coating layer, where the components of the coating layer include the above-mentioned coating material or a coating material prepared by the above-mentioned preparation method. The above-mentioned coating material is applied to at least part of outer surfaces of the heat exchange tubes and/or fin(s) of the heat exchanger.

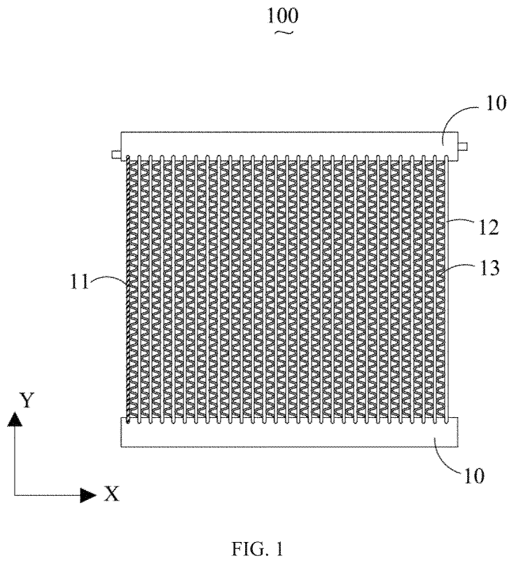

Exemplarily, as shown in FIGS. 1 and 2, the main structure of the heat exchanger 100 includes two headers 10, a plurality of heat exchange tubes 12, and at least one fin 13, the heat exchange tube 12 is fixed to the header 10, an inner cavity of the heat exchange tube 12 is in communication with an inner cavity of the header 10, and the fin 13 is located between two adjacent heat exchange tubes 12.

In some embodiments, the heat exchanger 100 is configured as a micro-channel heat exchanger. The plurality of heat exchange tubes 12 are arranged along a length direction of the header 10 (direction X in FIG. 1), the width of the heat exchange tube 12 is greater than the thickness of the heat exchange tube 12, a width direction of the heat exchange tube 12 (direction D in FIG. 2) is not co-directional with the length direction of the header 10. The fin 13 is of a corrugated structure extending along a length direction of the heat exchange tube 12. The fin 13 includes a plurality of fin units 131 arranged along the length direction of the heat exchange tube 12 (Y direction Yin FIGS. 1 and 2), the plurality of fin units 131 are connected in sequence, wave crests or valleys in the corrugated structure corresponding to the fin 13 are formed at positions where adjacent fin units 131 are connected, and the fin 13 is fixed to the heat exchange tube 12 at the positions where the adjacent fin units 131 are connected. At least part of the outer surface of at least one of the header 10, the heat exchange tube 12, and the fin 13 is provided with a coating layer 11, and the coating layer 11 may be formed by coating the coating material of the foregoing embodiment. In FIG. 1, the coating layer 11 is illustrated with reference to a shaded part on the surface of the leftmost heat exchange tube 12. In other embodiments, the surfaces of other heat exchange tubes 12, fins 13, and headers 10 may all be coated with the coating material to form the coating layer 11.

Two headers 10 are shown in FIG. 1, the heat exchange tube 12 is connected between the two headers 10, the width of the heat exchange tube 12 is greater than the thickness of the heat exchange tube 12, and a plurality of heat exchange channels 121 extending along the length direction of the heat exchange tube 12 are formed inside the heat exchange tube 12, so that the heat exchange tube 12 may be a micro-channel flat tube.

In some implementations, a window structure may be provided in some areas of the fin 13 to further enhance heat exchange.

In some embodiments, a material of at least one of the header 10, the heat exchange tube 12, and the fin 13 includes a metal base 41. The metal base 41 may be, for example, aluminum, aluminum alloy, stainless steel, and the like. At least part of the outer surface of the metal base is applied with a coating layer.

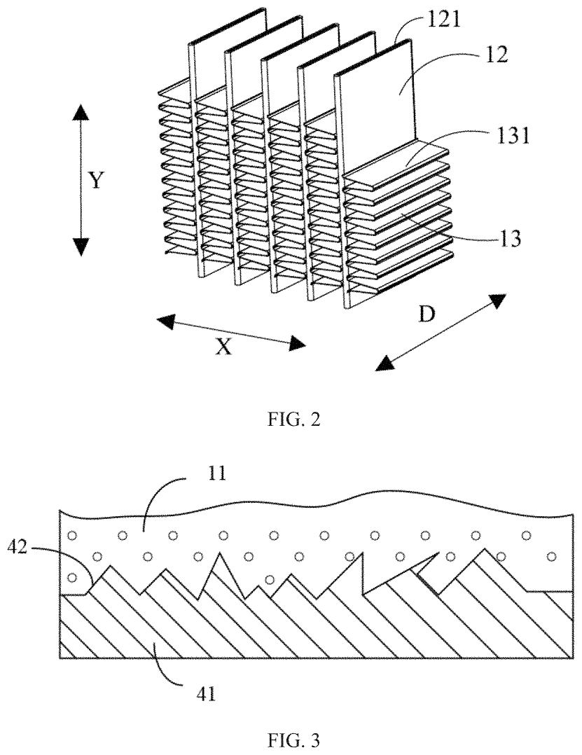

As shown in FIG. 3, in some embodiments, the outer surface of the metal base has an uneven rough surface 42, and the roughness (denoted as Ra) of the rough surface 42 meets 0.5 μm≤Ra≤10 μm. Exemplarily, the roughness of the rough surface 42 is 0.5 μm, 1 μm, 2 μm, 3 μm, 4 μm, 5 μm, 6 μm, 7 μm, 8 μm, 9 μm, 10 μm and any value in a range formed by any tow of these point values. It can be understood that controlling the roughness of the outer surface of the metal base within the above range is beneficial to the adhesion of the coating layer 11.

Further, the micro-channel heat exchanger is an all-aluminum micro-channel heat exchanger. Connection relationships between the structure of the micro-channel heat exchanger and the various components are conventional knowledge in the art and will not be repeated here.

In some implementations, an average thickness of the coating layer 11 may be greater than or equal to 0.075 mm.

In view of the structural characteristics of the micro-channel heat exchanger, the surface temperature of the fin is the most important factor affecting the frosting of the heat exchanger. Generally, the low and uneven surface temperature of the fin will cause uneven distribution of a frost layer, and thus worsens the heat transfer of the heat exchanger and accelerates frosting. A louvered fins is adopted in most of the micro-channel heat exchangers adopt, of which the fin spacing is very small, and the fin temperature is low, leading to a “bridging” phenomenon between the condensed water droplets on the super-hydrophobic surface. The condensed water is accumulated at tips of the fins and is difficult to discharge. When the frost forms again, the condensed water freezes and aggravates the frosting after the second frosting cycle. Therefore, in this micro-channel heat exchanger, at least part of the surface of the fin has a coating layer formed thereon by coating the above-mentioned coating material.

According to the embodiments of the present disclosure, the surface treatment is carried out on the micro-channel heat exchanger by using the coating material prepared from the light-to-heat conversion material combined with the hydrophobically modified silica sol, which can make the surface temperature of the fins increase effectively under the irradiation of visible light, slow down the frosting, and effectively exert the effects of the super-hydrophobic surface in discharging condensed water and slowing down frosting. In addition, the surface temperature of the fins should not be raised too high, for example, when the temperature rises above 2° C., the heat exchange efficiency of the heat exchanger will be affected.

An embodiment of the present disclosure further provides a treatment method for the heat exchanger, including the following steps:

applying a coating material to the outer surface of at least one of the header 10, the heat exchange tube 12, and the fin 13 of the abovementioned heat exchanger 100. The coating material includes a light-to-heat conversion material.

Further, in the process of treating the heat exchanger of the present disclosure with the coating material, the various components of the heat exchanger have been assembled and fixed into a heat exchanger. The outer surface of at least one of the header 10, the heat exchange tube 12, and the fin 13 may be pretreated first, and then the coating material is coated on the pretreated outer surface of at least one of the header, the heat exchange tube, and fin.

Specifically, in some embodiments, the outer surface of at least one of the header 10, the heat exchange tube 12, and the fin 13 of the heat exchanger is pretreated. The pretreatment step of the heat exchanger specifically includes: sandblasting the outer surface of at least one of the header 10, the heat exchange tube 12, and the fin 13 with blasting sand of 100 to 200 meshes, then cleaning the surface of the heat exchange tube and/or fin with alcohol or acid, and then drying at a temperature of 35° C. to 50° C.

Further, in some embodiments, during the pretreatment process, the blasting sand is of 120 to 180 meshes, for example, the blasting sand is of 150 meshes. The drying temperature is within a range of 35° C. to 50° C., and further, in some embodiments, the drying temperature is within a range of 38° C. to 45° C., for example, 40° C. The cleaning method used may be, for example, ultrasonic cleaning with anhydrous ethanol or acid etching.

In some embodiments, the above-mentioned treatment method for the heat exchanger further includes a pretreatment step for the coating material before coating the coating material, and the pretreatment step for the coating material includes a step of diluting the coating material with a solvent. Specifically, the solvent may be deionized water or an alcohol solvent. For example, the coating material may be diluted by volume with deionized water, and the dilution ratio may range from 1% to 100%. In view of the cost and performance comprehensively, the dilution ratio preferably ranges from 30% to 50%.

In some embodiments of the present disclosure, a coating method of the coating material includes but is not limited to at least one of dip coating, spray coating, brushing coating, curtain coating or roller coating. In view of the convenience of implementation, the coating material of the embodiment of the present disclosure may be coated to the pretreated outer surface of at least one of the headers 10, the heat exchange tube 12, and the fin 13 by spray coating or dip coating, where time of dip coating is 2 to 5 min, and further may be 2 to 3 min; the dip-coating is carried out 2 to 5 times, and further may be carried out twice or three times.

In some embodiments, the coating material is coated to the pretreated outer surface of at least one of the headers 10, the heat exchange tube 12, and the fin 13, and then cured at a temperature of 120° C. to 150° C., further operationally at 135° C. to 145° C., and further operationally at 140° C. The curing time is 0.5 h to 2 h, further may be 0.8 h to 1.5 h, and further may be 1 h.

By adopting the coating material on the heat exchanger, the surface treatment conditions of the abovementioned heat exchanger are adjusted and optimized to obtain a heat exchanger with a super-hydrophobic coating layer that can slow down frosting. By test, the coating layer that can slow down frosting has a contact angle greater than 150° and achieves good hydrophobic performance, and thus can slow down the frosting behavior of the heat exchanger.

In other implementations provided by the present disclosure, the coating material of the present disclosure may also be applied to products other than heat exchangers, such as heat-pump water heaters. When the coating material of the implementations of the present disclosure is applied to a surface of a water heater, the light-to-heat conversion material may also preserve or provide heat for the water heater, thereby saving energy to a certain extent. Certainly, the coating material of the implementations of the present disclosure may also be applied to other products that require hydrophobicity and/or surface temperature rise.

In order to fully illustrate the performance of the coating material of the present disclosure that can slowing down frosting and facilitate the understanding of the present disclosure, the present disclosure has been verified by multiple sets of experiments. The present disclosure will be further explained below in conjunction with specific examples and comparative examples. Those skilled in the art will understand that the descriptions in the present disclosure are only part of examples, and any other suitable specific examples are within the scope of the present disclosure.

### Embodiment 1

1. Preparation of Coating Material

(a) 28 parts by mass of hexamethyldisilazane (HMDS), 71 parts by mass of ethanol and 1 parts by mass of hydrophilic silica were mixed and the reaction occurred under mechanically stirred at 250 rpm to react for 30 min in a water bath at 35° C., so as to obtain hydrophobically modified silica sol.

By test, the pH value of the hydrophobically modified silica sol was 11.5.

The reaction equation involved in step (a) was as follows:

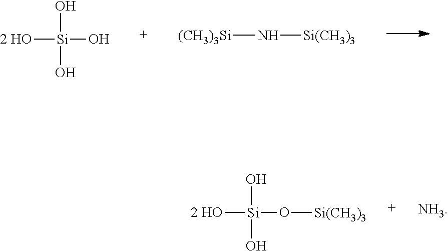

(b) 0.5 parts by mass of a light-to-heat conversion material nano copper oxide and 3 parts by mass of a dispersant were added to the hydrophobically modified silica sol obtained in step (a), and the resulting solution was mechanically stirred to be uniform to obtain the coating material.

2. Treatment of the Heat Exchanger

(c) The surface of at least one of the header 10, the heat exchange tube 12, and the fin 13 of the heat exchanger was pretreated. Specifically, the surface of at least one of the header 10, the heat exchange tube 12, and the fin 13 was sandblasted with blasting sand of 150 meshes, and then the surface of the heat exchange tube and/or the fin of the heat exchanger was cleaned with absolute ethanol, and then dried at 40° C.

(d) The surface of at least one of the header 10, heat exchange tube 12, and fin 13 was coated with the coating material obtained in step (c) by dip-coating or spray coating, and then the coating material was cured at 140° C. for 1 h to obtain a heat exchanger with the coating layer.

By test, a contact angle of the surface of the heat exchanger with this coating layer was greater than 150°.

The hydrophobic principle of the surface of the heat exchanger having coating material coated thereon was shown as follows, where the hydroxyl group (—OH) was a hydrophilic group, which was dehydrated and condensed with the hydroxyl group (—OH) of an aluminum base of the heat exchanger, and the methyl group (—CH₃) was a hydrophobic group, so that the surface of the heat exchanger coated with the coating material had strong hydrophobicity.

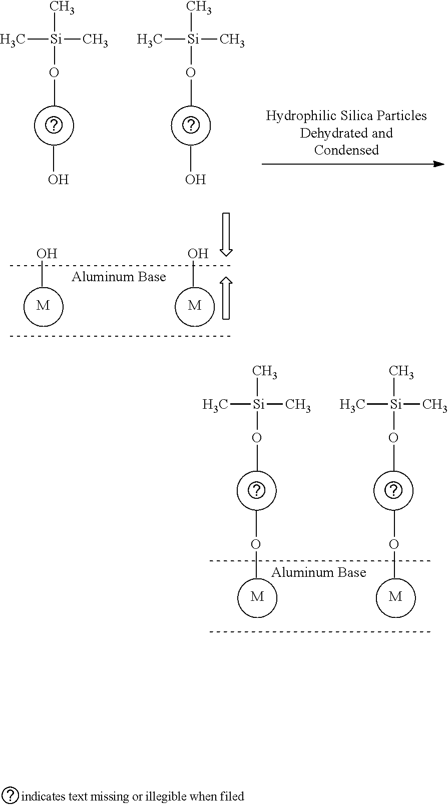

### Embodiments 2 to 6

The coating material was prepared and the heat exchanger was treated in the same manner as in Embodiment 1, except for the dosage and type of the light-to-heat conversion material.

Embodiment 2 differs from Embodiment 1 in that 1.0 parts of the light-to-heat conversion material nano copper oxide was added.

Embodiment 3 differs from Embodiment 1 in that 2.0 parts of the light-to-heat conversion material nano copper oxide was added.

Embodiment 4 differs from Embodiment 1 in that 1.0 parts of the light-to-heat conversion material spinel material was added.

Embodiment 5 differs from Embodiment 1 in that 0.5 parts of the light-to-heat conversion material spinel material was added.

Embodiment 6 differs from Embodiment 1 in that 1.0 parts of the light-to-heat conversion material nano carbon material was added.

### Embodiments 7 to 10

The coating material was prepared and the heat exchanger was treated in the same manner as in Embodiment 1, except for the dosage and type of the organosilane.

Embodiment 7 differs from Embodiment 1 in that 10 parts of hexamethyldisilazane (HMDS) was added.

Embodiment 8 differs from Embodiment 1 in that 50 parts of hexamethyldisilazane (HMDS) was added.

Embodiment 9 differs from Embodiment 1 in that 28 parts of methyltriethoxysilane (MTES) was added.

Embodiment 10 differs from Embodiment 1 in that 28 parts of trimethylchlorosilane (TMCS) was added.

### Embodiments 11 to 13

The coating material was prepared and the heat exchanger was treated in the same manner as in Embodiment 1, except for the dosage and type of the solution and hydrophilic silica.

Embodiment 11 differs from Embodiment 1 in that 50 parts of ethyl alcohol was added.

Embodiment 12 differs from Embodiment 1 in that 85 parts of isopropanol was added.

Embodiment 13 differs from Embodiment 1 in that 5 parts of hydrophilic silica was added.

### Embodiment 14

Embodiment 14 differs from Embodiment 1 in the preparation of the coating material.

The preparation of the coating material in Embodiment 14 was carried out as follows:

(a) 28 parts by mass of hexamethyldisilazane (HMDS), 71 parts by mass of ethanol and 1 part by mass of hydrophilic silica are mixed and the reaction was mechanically stirred at 250 rpm to react for 30 min in a water bath at 35° C., so as to obtain hydrophobically modified silica sol.

(b) 3 parts by mass of a light-to-heat conversion material was added to the hydrophobically modified silica sol obtained in step (a), and the resulting solution was mechanically stirred to be uniform, so as to obtain the coating material.

In Embodiment 14, since no dispersant was added to the coating material, miscibility of the light-to-heat conversion material and the hydrophobically modified silica sol was poor comparing with that in Embodiments 1 to 13, and the light-to-heat conversion material is likely to precipitate. Therefore, during the treatment for the heat exchanger, the coating material may be coated to the heat exchanger by dip-coating or spray coating in Embodiment 1, and the coating material may be sprayed onto the heat exchanger in preparation of the heat exchanger in Embodiment 14.

### Embodiment 15

The heat exchanger was treated in the same manner as in Embodiment 14, except for the preparation of the coating material.

The preparation of the coating material in Embodiment 15 was carried out as follows:

(a) 35 parts by mass of dimethyl diethoxysilane (DDS), 80 parts by mass of ethanol and 1.5 parts by mass of hydrophilic silica were mixed, and the resulting solution was mechanically stirred at 300 rpm to react for 25 min in a water bath at 40° C., to obtain hydrophobically modified silica sol.

(b) 2.5 parts by mass of a light-to-heat conversion material was added to the hydrophobically modified silica sol obtained in step (a), and the resulting solution was mechanically stirred to be uniform to obtain the coating material.

### Comparative Embodiment 1

Comparative Embodiment 1 differs from Embodiment 1 in that no coating material was used for treating the heat exchanger in Comparative Embodiment 1.

### Comparative Embodiment 2

Comparative Embodiment 2 differs from Embodiment 1 in that no light-to-heat conversion material was used for treating the heat exchanger in Comparative Embodiment 2, that is, no light-to-heat conversion material was added during the preparation process of the coating material.

Performance Test

Performance test were performed to the coating materials and the heat exchangers of the foregoing Embodiments and Comparative Embodiments, respectively. The test results were shown in Table 1 and Table 2 below.

The test method was as follows:

1. Contact Angle Test Method:

The contact angle referred to an angle formed at a solid-liquid-gas three-phase junction on a solid surface when a liquid phase was sandwiched by two tangents of a gas-liquid interface and a solid-liquid interface after a liquid drop falls on a horizontal solid plane. The test instrument used was a contact angle measuring instrument which measured the contact angle of a sample by an image profile analysis method based on the principle of optical imaging.

In the test, the contact angle measuring instrument and the computer connected thereto were turned on, and testing software was operated.

A sample was placed on a horizontal workbench, the amount of a droplet was adjusted by using a micro-injector. The volume of the droplet was generally about 2 μL. A droplet was formed on the needle. The knob was then turned to move the workbench up, so that the surface of the sample came into contact with the droplet. The workbench was then moved down, and then the droplet was left on the sample.

The contact angle of this area was obtained by testing and data analysis through the testing software. The sample of each of Embodiments and Comparative Embodiments was tested at 5 different points and an average value was taken and recorded as the contact angle of the sample of the Embodiment and of the Comparative Embodiment.

2. Surface Temperature Test Method:

The instrument used for the surface temperature test was a non-contact infrared thermometer. The surface temperature was determined by measuring the infrared energy radiated by a target.

The samples of each of the Embodiments and the Comparative Embodiments were placed in a fixed position and under the same light conditions, such as under continuous direct sunlight from noon to evening on a sunny day, or under low light in a corridor from noon to evening on a sunny day (under natural light, without lamp light).

Specifically, the samples of each of the Embodiments and the Comparative embodiments were placed in a test light environment, and the surfaces of the samples were tested with a non-contact infrared thermometer every 1 h. Temperature test method: the target was aimed by the thermometer at a distance of about 10 cm, the trigger was pressed for 10 seconds, and then the temperature indicated by the thermometer was read out.

The surface temperature of the heat exchanger with a coating layer was subtracted from the surface temperature of the heat exchanger without a coating layer (or a bare aluminum alloy sheet without a coating layer) to obtain temperature difference ΔT.

TABLE 1
Surface Temperature Test Results of Embodiments and Comparative Embodiments

| | ΔT over different sunlight exposure time (° C.) | | | | | | | | | |
|---|---|---|---|---|---|---|---|---|---|---|
| Item | 9:00 | 10:00 | 11:00 | 12:00 | 13:00 | 14:00 | 15:00 | 16:00 | 17:00 | Contact angle |
| Example | 0 | 0.5 | 0.4 | 0.8 | 1.4 | 0.8 | 1.2 | 0 | 0.9 | >150° |
| 1 | | | | | | | | | | |
| Example | 0 | 1.9 | 1.1 | 1.3 | 2.1 | 1.7 | 1.9 | 1 | 1.5 | >150° |
| 2 | | | | | | | | | | |
| Example | 0.1 | 0.7 | 0.7 | 1 | 1.4 | 1 | 1.2 | 0.4 | 1 | >150° |
| 3 | | | | | | | | | | |
| Example | 0.3 | 2.6 | 1.2 | 1.5 | 2.1 | 1.7 | 1.9 | 1 | 1.5 | >150° |
| 4 | | | | | | | | | | |
| Example | — | — | — | — | — | — | — | — | — | >150° |
| 5 | | | | | | | | | | |
| Example | — | — | — | — | — | — | — | — | — | >150° |
| 6 | | | | | | | | | | |
| Example | — | — | — | — | — | — | — | — | — | >150° |
| 7 | | | | | | | | | | |
| Example | — | — | — | — | — | — | — | — | — | >150° |
| 8 | | | | | | | | | | |
| Example | — | — | — | — | — | — | — | — | — | >150° |
| 9 | | | | | | | | | | |
| Example | — | — | — | — | — | — | — | — | — | >150° |
| 10 | | | | | | | | | | |
| Example | — | — | — | — | — | — | — | — | — | >150° |
| 11 | | | | | | | | | | |
| Example | — | — | — | — | — | — | — | — | — | >150° |
| 12 | | | | | | | | | | |
| Example | — | — | — | — | — | — | — | — | — | >150° |
| 13 | | | | | | | | | | |
| Example | — | — | — | — | — | — | — | — | — | >150° |
| 14 | | | | | | | | | | |
| Example | — | — | — | — | — | — | — | — | — | >150° |
| 15 | | | | | | | | | | |
| Control 2 | 0.1 | 0.2 | 0.3 | 0.2 | 0.6 | 0.3 | 0.4 | 0 | 1 | >150° |

TABLE 2

| Item | Contact angle |
|---|---|
| Control 1 | <100° |

Examples 1 to 15 represent Embodiments 1 to 15, Control 1 represents Comparative Embodiment 1, and Control 2 represents Comparative Embodiment 2. “-” represents not tested. Table 1 shows the results of test in which the samples of each of the embodiments and comparative embodiments were placed on a wooden frame and under continuous irradiation of low light in a corridor from 9:00 am to 5:00 pm on a sunny day in August 2020 (under natural light, without lamp light).

From the data in Table 1, it can be seen that the contact angles of the coating layers of the heat exchangers in the embodiments of the present disclosure are all greater than 150°, the hydrophobicity is increased, and excellent hydrophobic performance can promote the discharge of condensed water in a confined space. Under irradiation of visible light, the surface temperature of the heat exchanger can be effectively increased, the surface frosting can be slowed down, and the surface temperature rise of the heat exchanger generally does not exceed 2° C., and thus the heat exchange performance of the heat exchanger can be ensured. It can be seen from the data in Table 2 that when the surface of the heat exchanger is not coated with the coating material, the tested contact angle is less than 100°. The contact angle between water droplets and the wall of the heat exchanger is relatively small, and the corresponding contact area is relatively large. As a result, the water droplets freeze faster, which causes rapid frosting.

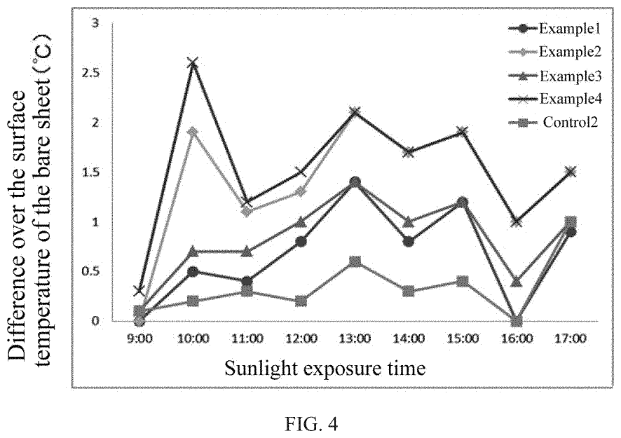

In addition, FIG. 4 shows a surface temperature test diagram of some embodiments of the present disclosure and Comparative Embodiment 2. In FIG. 4, the test time is taken as the abscissa, and the temperature difference ΔT obtained by subtracting the surface temperature of the heat exchanger with a coating layer from the surface temperature of the bare aluminum alloy sheet without a coating layer is taken as the ordinate. It can also be seen from FIG. 4 that the coating layer of the heat exchanger in the embodiment of the present disclosure can effectively increase the surface temperature of the heat exchanger and slow down the frosting on the surface under the irradiation of visible light. Compared with Comparative embodiment 2, the coating material having the light-to-heat conversion material added therein has the temperature rise significantly higher than that of the coating material without the light-to-heat conversion material in each of time periods. It is verified to some extent from a side that, the light-to-heat conversion material can effectively increase the surface temperature of the heat exchanger, and by the formulation of the coating material of the present disclosure, the surface temperature rise of the heat exchanger would not be too high, which would basically not exceed 2° C., which has a relatively good effect on slowing down frosting and will not have a major impact on the heat exchange performance of the heat exchanger. That is, the effect of slowing down frosting and the heat transfer performance can be both ensured.

In the description of the present disclosure, the description with reference to the terms “one embodiment”, “some embodiments”, “exemplary embodiment”, “example”, “specific example”, “some examples” or the like means specific features, structures, materials or characteristics described in connection with the embodiment or example are included in at least one embodiment or example of the present disclosure. In the present specification, the schematic representations of the above terms do not necessarily refer to the same embodiment. Moreover, the specific features, structures, materials, or characteristics described may be combined in a suitable manner in any one or more embodiments or examples. Directional words such as “upper”, “lower”, “inside”, “outer”, etc., used in embodiments of the present disclosure are used for description based on the accompanying drawings and should not be understood as a limitation on the embodiments of the present disclosure.

While the embodiments of the present disclosure have been shown and described, it will be understood by those skilled in the art that the various modifications, changes, substitutions and variations of the embodiments may be made without departing from the spirit and scope of the present disclosure. The scope of the present disclosure is defined by the appended claims and their equivalents.

What is claimed is:

1. A coating material for coating a heat exchanger, comprising a hydrophobic material and a light-to-heat conversion material.

2. The coating material according to claim 1, wherein a dosage of the hydrophobic material is 92 to 98.5 parts by mass and a dosage of the light-to-heat conversion material is 0.5 to 3 parts by mass.

3. The coating material according to claim 1, wherein the coating material further comprising a dispersant;
wherein a dosage of each component in the coating material is as follows: a dosage of the hydrophobically material is 92 to 98.5 parts by mass, a dosage of the light-to-heat conversion material is 0.5 to 3 parts by mass, and a dosage of the dispersant is 1 to 5 parts by mass.

4. The coating material according to claim 1, wherein the light-to-heat conversion material comprises at least one of nano copper oxide, a spinel material, a nano carbon material, a conjugated polymer, black phosphorous, and a noble metal nanomaterial.

5. The coating material according to claim 1, wherein the hydrophobic material is a hydrophobically modified silica sol.

6. The coating material according to claim 3, wherein the dispersant comprises at least one of a polymer dispersant, an anionic wetting dispersant, a cationic wetting dispersant, a non-ionic wetting dispersant, an amphoteric wetting dispersant, and an electrically neutral wetting dispersant.

7. A preparation method of a coating material for coating a heat exchanger, comprising:
providing a hydrophobic material and a light-to-heat conversion material; and
mixing the hydrophobic material with the light-to-heat conversion material to obtain the coating material.

8. The preparation method according to claim 7, wherein the providing a hydrophobic material comprises:
mixing 10 to 50 parts of organosilane and/or siloxane by mass, 45 to 89 parts of a solvent and 1 to 5 parts of hydrophilic silica by mass, and stirring for 15 to 45 min at a temperature of 30° C. to 45° C. with a stirring speed of 200 to 500 rpm, to obtain the hydrophobic material.

9. The preparation method according to claim 8, wherein the method comprises at least one of the following features (1)-(3):
(1) the organosilane comprises at least one of hexamethyldisilazane, methyltriethoxysilane, dimethyl diethoxysilane, trimethylchlorosilane, dimethyldichlorosilane, and γ-glycidoxypropyltrimethoxysilane;
(2) the solvent comprises an alcohol solvent; or
(3) the hydrophilic silica comprises at least one of fumed silica particles and a dispersible silica sol.

10. The preparation method according to claim 7, wherein the method comprises at least one of the following features (1)-(3):
(1) a dosage of the hydrophobic material is 92 to 98.5 parts by mass and a dosage of the light-to-heat conversion material is 0.5 to 3 parts by mass;
(2) the light-to-heat conversion material comprises at least one of nano copper oxide, a spinel material, a nano carbon material, a conjugated polymer, black phosphorous, and a noble metal nanomaterial; or
(3) before the mixing the hydrophobic material with the light-to-heat conversion material to obtain the coating material, the method further comprises: adding 1 to 5 parts by mass of a dispersant.

11. A heat exchanger, comprising:
a metal base defining a heat exchange channel for flowing at least one of a refrigerant and a coolant therein; and
a coating layer coated at least a part of an outer surface of the metal base;
wherein the coating layer comprises a light-to-heat conversion material.

12. The heat exchanger according to claim 11, wherein the heat exchanger is a micro-channel heat exchanger, the metal base comprising:
a first header defining a first inner cavity;
a second header defining a second inner cavity; and
a plurality of heat exchange tubes connecting between the first header and the second header, each heat exchange tube defining a third inner cavity in fluid communication with the first inner cavity and the second inner cavity;
wherein the first inner cavity, the second inner cavity and the third inner cavity forms the heat exchange channel.

13. The heat exchanger according to claim 12, wherein said metal base comprises a plurality of fins each sandwiched between two adjacent heat exchange tubes, and at least part of an outer surface of the header, the heat exchange tube and the fin is loaded with the coating layer.

14. The heat exchanger according to claim 12, wherein a length direction of the first header is parallel to a length direction of second header, a length direction of heat exchange tube is perpendicular to the length direction of first and second headers, and
wherein the plurality of heat exchange tubes are arranged along the length direction of the header, the dimension of the length of the heat exchange tube is greater than the dimension of the width of the exchange tube, and the dimension of the width of the heat exchange tube is greater than the dimension of the thickness of the exchange tube.

15. The heat exchanger according to claim 12, wherein said fin is a corrugated shape fin extending along the length direction of the heat exchange tube, the fin comprising:
a plurality of fin units connecting between two adjacent heat exchange tubes;
a plurality of wave crests connecting with one of the two adjacent heat exchange tubes; and
a plurality of wave valleys connecting with the other one of the two adjacent heat exchange tubes;
wherein the wave crests and the wave valleys are retained to the two adjacent heat exchange tubes.

16. The heat exchanger according to claim 11, wherein the outer surface of the metal base has an uneven rough surface, a roughness of the rough surface is denoted as Ra meeting with the following relationship: 0.5 μm≤Ra≤10 μm, and the coating material covers at least a part of the rough surface.

17. The heat exchanger according to claim 12, wherein the third inner cavity defines a plurality of micro channels.

18. The heat exchanger according to claim 11, wherein the coating layer comprises a dispersant;
wherein a dosage of each component in the coating material is as follows: a dosage of the hydrophobically material is 92 to 98.5 parts by mass, a dosage of the light-to-heat conversion material is 0.5 to 3 parts by mass, and a dosage of the dispersant is 1 to 5 parts by mass.

19. The heat exchanger according to claim 11, wherein the light-to-heat conversion material comprises at least one of a nano copper oxide, a spinel material, a nano carbon material, a conjugated polymer, a black phosphorous, and a noble metal nanomaterial.
